(19) United States
(12) Patent Application Publication
(10) Pub. No.: US 2007/0094390 A1
(43) Pub. Date: Apr. 26, 2007

(54) DELIVERY OF SENSITIVE INFORMATION THROUGH SECURE RSS FEED

(76) Inventor: Bill Nussey, Smyrna, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/163,567

(22) Filed: Oct. 23, 2005

(51) Int. Cl. G06F 15/173

(52) U.S. Cl. 709/225

(57) ABSTRACT

Content directed towards a user is identified and the content is modified to include confidential data. The confidential level of the data is determined and used in the creation of a personalized RSS feed that gives a user controlled access to the data. Thus, commercial content providers can be utilized to create content to be delivered, such as through high-volume email, and the content can be modified to include confidential information that a company does not wish to disclose to outsourced service providers.

### CROSS-REFERENCE TO RELATED APPLICATIONS

“GENERAL PURPOSE RSS CATCHER”, filed on Oct. 23, 2005 and assigned Ser. No. 11/163,563, and identified as docket number 19011.1610, “PROVISION OF SECURE RSS FEEDS UTILIZING A SECURE RSS CATCHER”, filed on Oct. 23, 2005 and assigned Ser. No. 11/163,565, and identified as docket number 19011.1620, “DELIVERY OF NON-SENSITIVE AND SENSITIVE INFORMATION BASED ON CLASSIFICATION OF CONTENT”, filed on Oct. 23, 2005 and assigned Ser. No. 11/163,566, and identified as docket number 19011.1630, “FEEDBACK METRICS FOR RSS FEEDS”, filed on Oct. 23, 2005 and assigned Ser. No. __/___,___ and identified as docket number 19011.1650, and “INDIVIDUALIZED RSS FEEDS WITH ARCHIVES AND AUTOMATIC CLEANUP”, filed on Oct. 23, 2005 and assigned Ser. No. __/___,___ and identified as docket number 19011.1660.

### BACKGROUND OF THE INVENTION

The present invention is related to the field of Internet communication, and, more particularly, to the field of secure, reliable and controlled communication channels for the electronic delivery of information over the Internet free from vulnerabilities including SPAM and phishing.

Those connoisseurs of the pinkish, rubbery and oddly shaped meat product, or meat-oriented product, called SPAM may not fully understand or appreciate the reasoning behind the application of that name to the hordes of unwanted and unsolicited email messages that bombard your electronic in-boxes. For the rest of us, it totally makes sense. Even the most novice marketer can recognize the power and effectiveness of utilizing email as a medium to “get the word out” and get advertisements in front of potential customers. However, the same features of the current email system and capabilities that make it so useful, are too easily exploited by unscrupulous spammers that simply push as much content as possible to as many destinations as possible. Thus, as is experienced by the rest of the world, our in-boxes are filled with tasteless, undesired, and certainly unwelcome email messages or, also known as SPAM.

Unfortunately, spammers are not only giving legitimate email marketers a bad name, but they are reducing the effectiveness of email as a viable medium for such marketing and, more importantly, reducing its value of email communication to everyone—particularly end users who must plow through garbage to get the stuff they need.

Nonetheless, it is clear that email marketing is a beneficial, powerful, and viable marketing tool and it should be appreciated that not all bulk email is considered to be SPAM. There are many, top-tier and reputable marketing companies and organizations that send SPAM free high-volume emailing to their customers, subscribers, contacts, colleagues, etc. Among these companies is SILVERPOP, a leading provider of permission-based email marketing solutions, strategy and services. Bulk email is a type of high-volume email that generally is focused on sending large volumes of the same message to many recipients. High-volume email can include bulk email, but also includes applications in which a large number of customized messages are sent to various recipients. High-volume email solutions allow for email marketing systems to push notices, newsletters, and other legitimate content to interested parties that have granted permission to the marketers. As a result, SILVERPOP provides a lower cost communication channel for the delivery of such content, at least lower than typical call centers or print,for clients to talk with their customers.

Benefits associated with the use of email and high-volume email marketing over traditional marketing include significant reductions in the cost of communicating with customers, reductions in the number of calls into your call center while driving customer loyalty, and assurance that every customer touch point is relevant, timely, legally compliant and brand appropriate. These are common benefits that are available through email marketing; however, the dramatic growth of SPAM threatens the usefulness of this marketing technique. Irregardless of the dramatic increase in the use of SPAM, most true marketers will tell you that unsolicited and annoying emails are not effective activities for serious marketers with real customer relationships and real brands. Email marketing, similar to all marketing, is about long-term relationships, customer communications and unprecedented improvements in customer loyalty and life-time value. What is needed in the art is a technique to provide for electronic and email marketing that allows the marketing touches to be distinguished from SPAM.

Today, individual SPAM victims have little recourse. SPAM messages may include a link to select if you wish to have your email address removed from the spammer's list. However, by traversing that link, you basically notify the spammer that you are alive and viable, that your email address is valid and policed, and such action may only encourage additional SPAM to be delivered to your email address or, even worse, may support the selling of your contact information to other spammers. So, most SPAM victims must simply browse through their in box and delete the emails that appear to be SPAM.

Another alternative to manually cleaning the SPAM out of your in-box is to utilize a SPAM filter. Most email clients or email applications include user defined SPAM filters. Such filters allow a user to forward email to different boxes or move email to a different folder based on header information associated with the email. Thus, emails from certain email address, domains, specific subject lines, keywords etc. can be detected and treated differently. In addition, some email applications, such as MICROSOFT OUTLOOK, allow you to tag certain email senders as being on a junk mail list. Thus, there are a variety of SPAM filters including header filters, language filters, content filters, etc. However, the available techniques require significant effort and policing on the part of the user. In addition, even with considerable effort on the part of the individual, SPAM filters are not always as effective as desired. In addition, application of the filters can also result in treating legitimate and desirable email as SPAM. This could result in significant consequences to the user.

Other techniques to control the influx of SPAM include SPAM filters and black list techniques that are employed by email hosting systems or ISPs. Systems such as this provide relief to the end user in that the filtering is done by the ISP or hosting system rather than the user. However, similar to the locally resident and defined SPAM filters, these systems can result in causing legitimate and desired email messages to be filtered and not reach the recipient. Thus, there is a need in the art for a technique to prevent a user from being inundated with SPAM, but that does not adversely affect the user's ability to receive the desired email, including desired and welcomed email marketing or high-volume emails.

Another related but even more problematic exploitation of email is referred to in the industry as phishing. A common development with many companies that provide Internet based services is a need to prompt customers to provide information or take actions. For instance, a banking company may request a user to visit the banks website so that the customer can tend to recently received electronic bills. It is not feasible for such companies to expect their customers to periodically visit the company's website on their own in an effort to determine if such a need exists. Customers are generally too busy and have too many competing interests. Thus, email is an ideal solution for companies that provide Internet based services. By sending an email message to the customer, the service provider can notify the customer of the action that is required, and prompt the customer to visit the service provider's website to perform such action. However, because the validity of a source sending an email message cannot be guaranteed, the end customer is vulnerable to phishing.

Phishing exploits the inherent inability to ensure the validity of an email sender. As an example, a user may receive an email indicating that it is from a legitimate service provider that the customer uses. When the customer opens the email, he or she is presented with information that looks official. The information typically includes a link to a website that requests the user to provide personal information, such as performing account number verifications or entering the user's PIN or password and user ID to access the system. This information is then recorded by the phisher and then used in an adverse manner against the user. Clearly there is a need in the art for a technique for Internet based service providers to contact their customers and provide them with notice that they need to take an action or simply visit the company's website. However, being able to confirm to the customer that an email contact is an authentic communication from the service provider is a difficult challenge. Thus there is a need in the art for such a technique.

In addition, such a technique should also be able to provide other, state of the art criteria or functions that have become common place and expected in email communication. Such criteria include the ability to transfer multiple kinds of content, including text, graphics and rich media, and the ability to transfer personalized content. In addition, the authentication of the communication source needs to be performed in a transparent manner, meaning that the users do not need to take any additional actions, or the additional actions are minimized, and that leverages existing Internet security solutions. Finally, the authentication of the communication source solution needs to provide secure delivery, meaning that the delivery of the content cannot be intercepted either at the Internet Service Providers system, corporate data center, or by hackers using Internet sniffers or other similar techniques.

Another problem that is associated with the use of spam filters or anti-spam systems is that there is a probability that legitimate email messages may be blocked. The term used to identify legitimate emails that have been blocked is “false positives”. In practice, some have suggested that stopping the delivery of SPAM to a system is not nearly as difficult of a task as avoiding false positive results. Eliminating false positives is a very difficult problem to address for email recognition and filtering technologies and failures on the functionality of this effort can be catastrophic in a business setting. A false positive result can quite costly to a company if they are losing business opportunities that were attempted to be delivered via email.

Most systems that are employed for eliminating junk email will most likely create false-positives and thus result in blocking legitimate email. The GIGA INFORMATION GROUP has indicated that based on real world testing, the rate of false-positives can be as high as 34%. ASSURANCE SYSTEMS has indicated that even the better junk email processing systems will still result in blocking 6% to 8% of legitimate email.

As has been described, the Internet and more particularly, email technology has been whole heartedly adopted by mass marketers in the form of high-volume email marketing and has also proven useful for Internet service providers to reach out and touch their customers. However, these advances in the art are deficient in that they are vulnerable to SPAM, phishing and deliverability. Thus, there is a need in the art for a solution that can not only be as effective as or exceed the present email technology techniques, but that can also eliminate the vulnerability of users to SPAM and phishing. As will be described herein, the present invention is such a solution.

Another communication and information delivery technology that has been rapidly gaining popularity is RSS feeds. Although some may argue what the acronym RSS actually stands for (RDF Site Summary, Rich Site Summary, Really Simply Syndication), the bottom line is that RSS is a relatively simple specification that uses extensive markup language (XML) to organize and format web-based content in a standard manner. Content owners create an RSS feed, an XML formatted web page or which usually consists of titles and brief descriptions of various articles or content that is available in various locations on the site. The XML formatted web page also includes links to these various articles. More specifically, an RSS feed is then an XML file with only a few fields allowing users to scan the title or headline, author and usually a brief abstract. In addition, if the user so desires, he or she can access the full article or document by actuating the retrieval address (i.e., an URL) that is associated with the entry in the XML file. Although RSS was originally designed for periodical publications, it has been used to deliver updates to web sites, blog articles, new learning objects and a host of other novel applications. In short, anything the owner wants “pushed” to the world. There are several similar standards that have been introduced for RSS, including RSS 1.0, RSS 2.0 and Atom. Although the term RSS is used extensively throughout this description, it should be understood that the present invention is not limited to the use of any one version or release or RSS but rather, that the present invention can incorporate the various releases or any similar, not yet released formats, as well as similar technologies. In addition, the files that are created and that support and RSS feed can vary depending on the actual implementation or version of RSS that is being utilized. For instance, RSS 2,0 utilizes XML files whereas RSS 1.0 utilizes RDF files, which are a version of XML files. Throughout this specification, reference to an XML file and an RDF file may be used interchangeably.

Content available through an RSS feed is obtained using a software client called an RSS reader or aggregator. The RSS feeds are based on an RSS standard and thus, they can easily be read by an RSS feed reader and most RSS feed readers can handle all of the current RSS standards. An RSS reader or aggregator is usually a stand alone program (though it may be integrated with an email program, an internet browser or other communications program) that periodically and automatically searches the Internet for new additions to any site to which the end user has subscribed. Some RSS readers will provide a popup window message when new material arrives on a subscribed RSS feed. Some RSS readers will check the RSS feeds for new content on a scheduled basis, while others wait until they are checked or actuated by the end user. Typically, the RSS readers can be customized as to the frequency of site checking and the ways that selected content is displayed. A user can subscribe to as many RSS feeds as they wish. RSS readers generally allow the user to define the manner in which the information is displayed. For instance, the information can be sorted by date and/or by the publisher of the data.

RSS feeds are similar to simply accessing web content through a browser but there is one, very significant difference. With an RSS feed, when any new material is available, the RSS feeds provide a very simple way for RSS readers to see when and what material has changed. RSS feed readers allow you to subscribe to feeds that you know contain important or useful information, and your RSS reader will notify you immediately whenever new content for your subscriptions is available. In short, once you've identified a useful resource that publishes an RSS feed, you can virtually skip searching for it altogether. In addition, the basic characteristics of RSS feeds allow users to be updated or informed of critical, real-time information as it becomes available. Advantageously, because the content coming from an RSS feed is controlled by the source, there is inherently a level assurance that the content can be trusted. The application of a technology such as an RSS feed could greatly benefit the delivery of advertisements, notifications and content in general from Internet service providers. Thus, there is a need in the art to utilize such a technology to provide for the delivery of content in a controlled manner and to allow Internet service providers to deliver trusted communications to customers.

In addition, there are clearly circumstances when content to be delivered to a recipient is confidential and requires additional security, and there are other circumstances with the content does not require such additional security. For instance, if the content being received includes advertisements, product notices, new letters or the like, there is no need for additional security. However, if personal information such as account balances, the performance of a trade, or similar content is being received, it is usually desirable to have additional protection mechanisms in place, such as requiring the recipient to enter a password or PIN. Thus, there is a need in the art to deliver content in a controlled manner that allows for the delivery of confidential content, as well as non-confidential content.

There are applications in which a company that provides confidential reports to its customers may require the employment of external companies in the preparation and forwarding of such reports. However, due to HIPA requirements and other obligations to maintain confidential information, a company may be prohibited from outsourcing such activities. However, often times the reports or content predominantly contain non-confidential information and as such, much effort could be outsourced without the need to disclose the confidential information. Nonetheless, incorporating the confidential information into the reports or content must still be performed in a secure manner. Thus, there is a need in the art for a solution to enable the use of outsourced services in the preparation of reports without divulging customer confidential information, and reaping the benefit of the high-volume delivery of such content with the inclusion of the confidential information in a protected or access controlled manner.

There are also applications in which it is desirable to provide mixed classifications of content in a single content delivery mechanism. For instance, many reports that are generated by banking institutes, medical companies, investment tracking and portfolio management companies, etc. may predominantly include non-confidential yet informative information along with confidential information. It may be desirable to view or enable the viewing of the non-confidential information, while maintaining access control to the confidential information. Thus, there is a need in the art for a solution that allows for the delivery of confidential reports with and/or without the inclusion of the confidential information.

### BRIEF SUMMARY OF THE INVENTION

The present invention addresses the above described needs in the art by providing a technique to electronically deliver information or content to users in a manner this is as convenient and easy to use as email, but that is immune to SPAM, deliverability problems and phishing vulnerabilities as well as other short-comings of email. More specifically, the present invention utilizes RSS feeds to provide the delivery and fabrication of reports and other content that contain confidential information while maintaining access control and preventing dissemination of the confidential information.

One aspect of the present invention is an RSS catcher. The RSS catcher advantageously can receive information from a variety of sources, and then make the information available to various customers through an RSS feed. In one embodiment, broadcasted information, such as information provided through a high-volume email system can be captured and converted into an RSS feed available for the general public. In another embodiment, broadcasted information provided through a high-volume email system or other content delivery system can be converted into a personalized RSS feed available for specific and intended customers. Advantageously, the employment of an RSS catcher allows for the delivery of content without the vulnerabilities that plague high-volume email technology. In addition, the RSS catcher technology operates to enable phishing free pushing of notifications to customers. Thus, the present invention provides, among other things, a general RSS catcher that includes a system that can be retrofitted into existing email marketing solutions or any system that organizes and facilitates the sending of email or other forms of content. Thus, the present invention operates to turn any email generating system or content provider system into a personalized RSS feed system.

One aspect of the present invention is the provision for the controlled delivery of content to a user wherein content items directed towards an address identifier are received. For each such content item, a database is examined, or simply the existence of an associated URL is searched for, to determine if content directed towards this address identifier has been previously received. If content items that include the address identifier have been previously received, then an RSS based file, such as an RDF or XML file is created with the URL including a unique identifier that is generated using at least the address identifier. Portions of the content of the content item is then used to create an entry in a main RSS based file while other portions may be placed into a separate XML based file that can be linked to from the main RSS based file. If content items have been previously received for that address identifier, the URL associated with the identifier is determined and the RSS based file addressable with the URL is modified to include an entry for the content item. Thus, a unique RSS feed is created for each uniquely addressed content item. For email messages, this would create a unique RSS feed for each uniquely addressed email. In other embodiments, a unique RSS feed can be created based on other criteria. A few examples include, but are not limited to, to/from address pairs, from addresses, domain portions of the “to” addresses, domain portions of the “from” address, key words in the subject or body of the message, etc. Advantageously, such variations allow for RSS feeds to be created that provide differing content. For instance, an RSS feed with all emails received from eBay, or an RSS feed with all emails directed towards a particular recipient but from a particular company.

Another aspect of the present invention is to create an RSS feed for a user based on the specific content or characteristics of the content. For instance, if confidential content is being provided, a personalized RSS feed utilizing a password protected RDF or XML file can be used to deliver the content only after a user has been validated/authenticated. Otherwise, a simple personalized RSS feed can be created.

Another aspect of the present invention is to create multiple RSS feeds for a user based on the specific content or characteristics of the content. For instance, if confidential content is being provided, a personalized RSS feed utilizing a password protected RDF or XML file can be used to deliver the content and, non-confidential content can simultaneously be provided through another RSS feed that does not require a password. In addition, other classifications can require further RSS feeds, such as but not limited to, password protected and encrypted RSS feeds, encrypted only RSS feeds, double encrypted RSS feeds, etc.

Yet another aspect of the present invention enables the generation of reports or content that includes confidential and non-confidential information. Often times, companies will generate reports or content to be delivered to customers that are based on standard templates, or at a minimum, includes some non-confidential data for formatting. This aspect of the present invention allows the generation of the non-confidential portions of the reports or content to be outsourced. The non-confidential reports are then delivered to the company electronically and the RSS catcher, running in the company's secure data center, operates to convert the delivery of the reports into an RSS feed. Furthermore, while converting the reports the RSS catcher can also incorporate the confidential information into the reports. In a more specific embodiment, the outsourced report can be created with the inclusion of certain fields that are designed to contain the confidential information. The reports are delivered to the RSS catcher through a content delivery system, such as a high-volume email system. The RSS catcher then incorporates the confidential information into the various fields and then makes the reports available through a personalized and controlled access RSS feeds to the customers. As those skilled in the art will appreciate, the content creation system can thus be operated externally to the company's secure data center yet still assist in the delivery of information that is securely maintained within the company's data center.

### BRIEF DESCRIPTION OF THE SEVERAL VIEWS OF THE DRAWING

FIG. 1 is a system diagram illustrating the environment for a typical high-volume email distribution and management system.

FIG. 2A is a system diagram of the employment of the RSS catcher aspect of the present invention, integrated into and operating in conjunction with a content delivery system.

FIG. 2B is a block diagram illustrating one solution for providing multiple content classifications.

FIG. 2C is a block diagram illustrating another solution for providing multiple content classifications.

FIG. 3A is a flow diagram illustrating the steps involved in the dual record personalized RSS feed for content delivery.

FIG. 3B is a flow diagram illustrating the steps involved in an exemplary embodiment of the RSS reader operation utilized within the present invention.

FIG. 3C is a flow diagram illustrating the steps involved in an exemplary embodiment of the present invention that provides dual RSS feeds to a merging RSS reader.

FIG. 4 is a functional block diagram illustrating the states involved in an exemplary embodiment of the present invention.

### DETAILED DESCRIPTION OF THE INVENTION

The present invention is directed towards the delivery of electronic information to users in a manner that is immune to the delivery of SPAM and phishing and provides for the delivery of mixed confidential levels of data using both single or multiple RSS feeds that are generated based on the characteristics of the content. More specifically, the present invention is directed towards an RSS catcher that is operable to convert content into multiple RSS feeds based the characteristics of the content, such as the sensitivity or confidentiality and to provide merged RSS feeds, or RSS feeds that can be merged on the receiving end, for the delivery of content that has varying levels of confidential information.

Now turning to the drawings in which like labels and numbers refer to like elements throughout the several views, various embodiments and aspects of the present invention are described more fully.

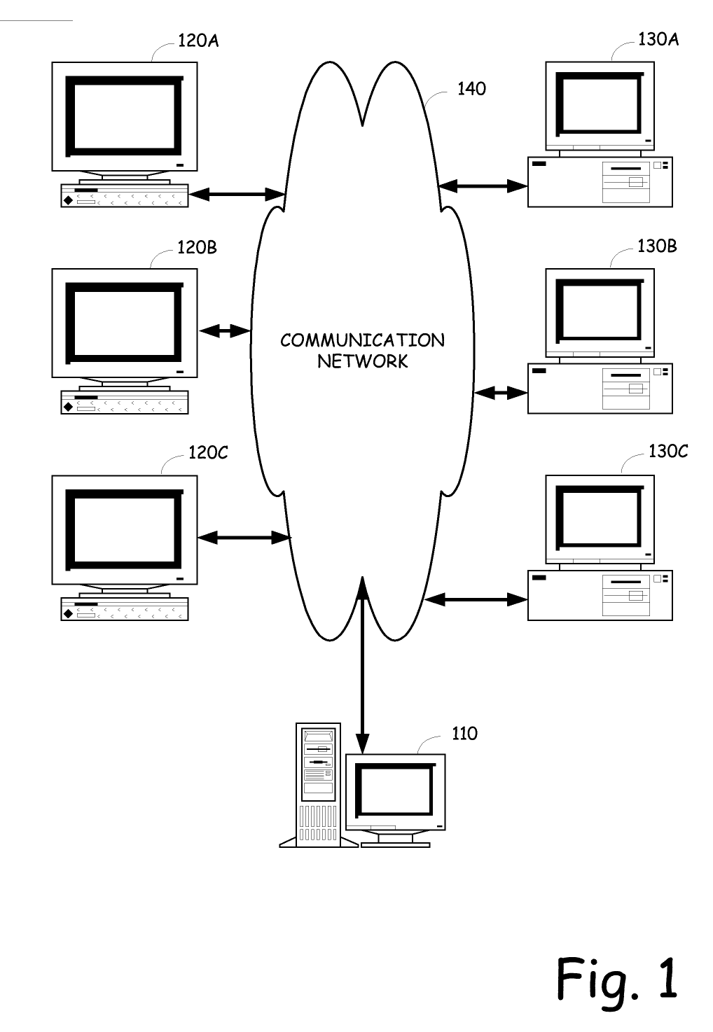

FIG. 1 is a system diagram illustrating the environment for a typical content distribution and management system, such as a high-volume email server. Although aspects of the present invention will be described within the context of a high-volume email server or system, the present invention is not limited to such a system, although such a configuration in and of itself is considered to be an optional aspect of embodiments of the present invention. A high-volume email server 110 is communicatively assessable to one or more marketing company systems 120A-C and one or more targets or recipients 130A-C. In general, the marketing companies employ the high-volume email server 110 for the delivery of information to recipients or a group of recipients. The recipients may be customers of a particular client of the marketing company, may be members of a private club, may be students in a university, may be purchasers of a particular product, or any of a variety of groups of parties. The marketing companies can interface to the high-volume email server 110 over a communications network, such as the Internet 140 or can be connected to the server through other means, such as but not limited to a VPN, a direct connection, a shared connection, a wireless connection, etc. In addition, it should be appreciated that the high-volume email server 110 may actually be incorporated into the marketing company system 120 or, the data required to generate a high-volume email delivery may be provided by a marketing company to the high-volume email server as a flat file through an FTP transfer or a diskette. Those skilled in the art will appreciate that other delivery mechanisms may also be employed.

An ultimate function of a high-volume email distribution system is to manage a set of recipients, provide a platform or mechanism for identifying recipients out of the domain of recipients for a particular email message, and in some instances, provide customization, personalization and creation of unique email message for each recipient as part of the high-volume delivery. For instant, in a high-volume email system developed by the assignee of the present invention, a recipient domain database is maintained within the high-volume email server. For each recipient in the database, various information and parameters about the recipient is maintained. The information provided is typically controlled by the customer, however in other embodiments, some of the information may be provided by the recipients, the high-volume email service provider, or from parties that have sold or provided the recipient database information.

The information or entries in the database are used to control the delivery of the high-volume email messages. This is accomplished by formulating queries on the various fields in the database. Thus, any particular high-volume email distribution can be delivered to a select portion of the domain of potential recipients simply by formulating a query for the selection of the recipients. Advantageously, this enables the high-volume email distribution to be more accurately targeted towards interested parties and as such, emails received through this system are relevant to the receiving party. In one version of the high-volume email system provided by Silverpop, the database of recipients includes up to 400 fields that can be used to characterize each recipient. The marketing company is free to customize the various fields to maximize the control and granularity of the email delivery.

Bulk email systems may also include further delivery controls. For instance, to protect a customer from being berated with an overwhelming amount of email, the high-volume email system may allow the recipient and/or the company to enter a parameter that limits the number of messages to be delivered to the recipient. For instance, a particular recipient may want to limit the system to 2-4 emails per month. Likewise, a company may decide to send no more than 1 email to each customer on a weekly basis. Bulk email systems may also include further controls on the number of email messages that the system will push over a particular time period. In addition, the high-volume email system may be equipped to handle campaign management which includes the ability for the system to send messages in accordance with particular parameters, such as the anniversary of a customer, the customer's birthday, thirty days after a customer makes a purchase, etc. Another aspect of high-volume email systems is the ability to include, or forcibly include in the messages, certain language such as legal disclaimers or the like—this is referred to as CAN-SPAM. One skilled in the art can readily see the benefits of a high-volume email system as described above in reaching customers and potential customers, and likewise, it is also clear how such a system can be abused. Rather than using queries for intelligently and selectively identifying a group of recipients for a high-volume emailing, and rather than limiting the number of messages that can be sent from the high-volume email system, an entity engaging in the practice of sending SPAM, can simply hit every party listed in the database with every message that is being sent out. Thus, any person that has obtained and utilizes an email box on the internet with an assigned email address, runs the risk of others discovering their email address and then placing that email address into a recipient database owned and exploited by SPAM senders. To avoid destroying their reputations, companies such as SILVERPOP must carefully scrutinize the users of their system and impose severe contractual requirements on them to assure that they do not engage in the practice of using the system for sending SPAM.

In the world of technology, and even in the world of Internet technology, RSS feeds are a relatively young development. Similar to most newly introduced technologies, no matter how technically sound and advantageous the technology is, the early adopters are generally only those that are the most technologically sophisticated. It takes a significant amount of time for new technology to catch on and become adopted by the majority of users. Internet marketers are just now beginning to focus on the benefits of using RSS feeds for the delivery of their information but as of yet, it is not widely adopted. As it stands, Internet marketing companies have significant amounts of money invested in their current high-volume email delivery systems. Thus, it is unlikely that in the near future, these systems will be totally abandoned for the newer RSS technology. However, as is shown herein, the present invention provides a solution that allows marketers to gain the benefit of their current high-volume email systems, and yet, also obtain the benefits available through the RSS feed technology.

It will be appreciated that a high-volume email system, as well as other content delivery systems may provide different types of content. For instance, the content may have varying degrees of confidentiality ranging from public to highly sensitive. Similarly, the content may have differing degrees of urgency ranging from non-sensitive delivery time to immediate delivery required.

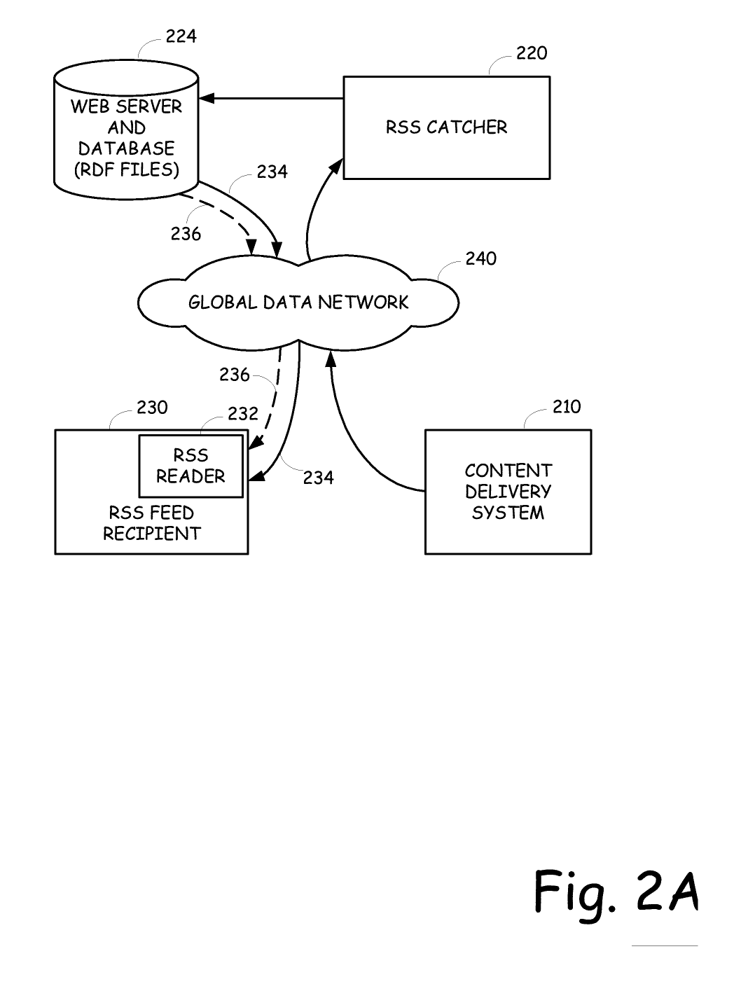

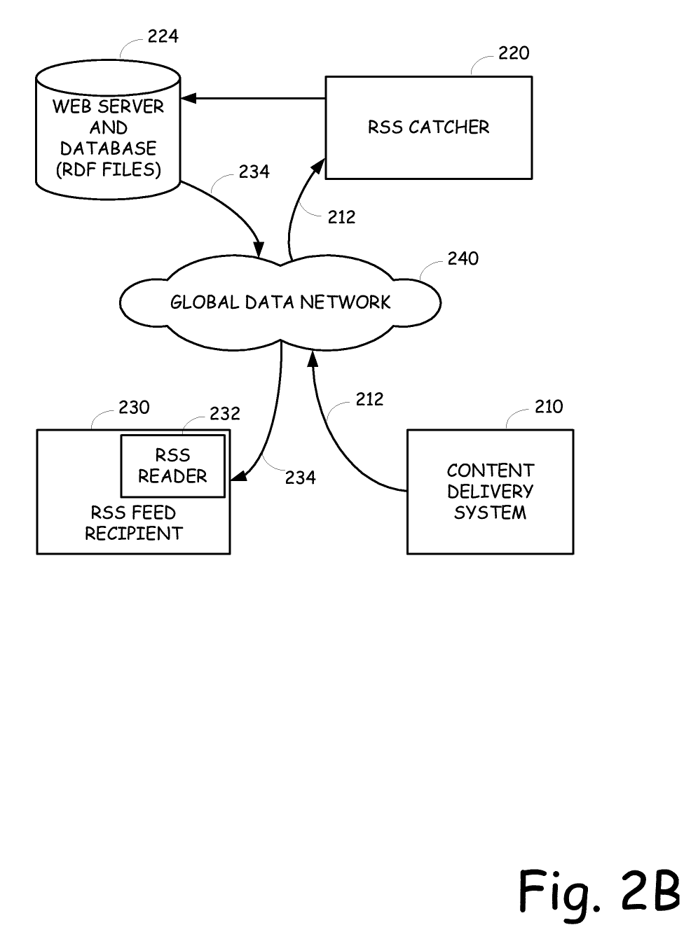

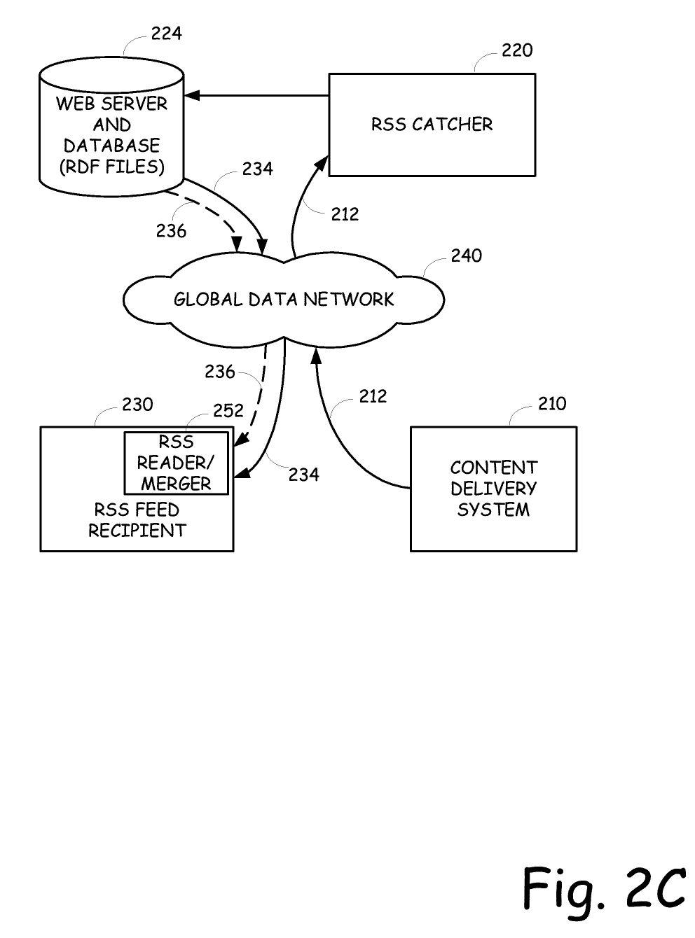

FIG. 2A is a system diagram of the employment of the RSS catcher aspect of the present invention, integrated into and operating in conjunction with currently available high-volume email technology. A content delivery system 210, similar to the exemplary high-volume email system described above, is configured to provide varied content delivery services. The content delivery system 210 delivers content items targeted for individual recipients or groups of recipients over a data network 240. The data delivery can be any of a variety of mediums including wired and wireless, secure and non-secure, dedicated or shared, etc.

An RSS catcher 220 is communicatively coupled to the data network 240 and is operable to receive the incoming content items from the content delivery system 210 and convert them into RSS feeds. This can be accomplished in a variety of manners. One exemplary embodiment of the present invention examines the content items to identify the targeted recipient of the content item and the characteristics of the content (i.e., sensitive or non-sensitive). When the RSS catcher 220 identifies the targeted recipient and the classification of the content item, the RSS catcher 220 then either creates an appropriate RSS feed for the content item if one does not already exist, or, inserts the content into the appropriate previously created RSS feed. For non-sensitive content, the RSS feed 220 simply takes the content item and generates a unique RSS feed 234 for that message. For sensitive content, the RSS catcher 220 generates a password protected and/or otherwise protected RSS feed 236. Thus, groups of related content items can be formed into a single RSS feed depending on the characteristics of the content. For instance, for email based content items, all emails that contain similar subjects, or that originate from a single source such as the same company or that are marked as urgent could be grouped into a single RSS feed. Likewise, all emails that include terms in the subject or other portions of the email such as “confidential”, “privileged”, “sensitive”, “secret”, “attorney client privileged”, “sensitive”, “your eyes only” etc. can be grouped into a single RSS feed while the remaining email could be grouped into another RSS feed. Advantageously, the first RSS feed can be protected using password access, identification through questioning, encryption, etc. The second RSS feed can be simply access by using the unique URL.

Oftentimes, information will be such that a company does not want to share, or is prohibited from sharing the content with outsourced content delivery companies. For instance, if a financial institute employs a high-volume email company to generate and email end of the month statements, the financial institute may be prohibited from providing certain financial information to the high-volume email company. Similarly, a company may desire to send out an email letter campaign with each letter containing personalized content that the company does not want to be disseminated to the high-volume email company. Such information could be confidential information such as social security numbers, address information, medical information, financial information or the like, or simply just information that the company does not want to risk dissemination.

The present invention provides a solution to this situation in a variety of manners. FIG. 2B is a block diagram illustrating one solution for providing multiple content classifications. In this embodiment, a content source 210 is employed to provide a templated or partially completed content item to be directed towards customers. Thus, the content that travels over path 212 to the RSS Catcher 220 is non-confidential information, or at a minimum, information that is protected through encryption or some other means. In one embodiment of the present invention, the RSS Catcher 220 receives the content items and identifies the party to whom the content item is directed. The RSS Catcher 220 can then augment, modify, edit or otherwise incorporate into the content item, further information. The further information can include confidential information particular to the intended recipient, or confidential information that a company did not want to share with an outside vendor, or information that is so rapidly changing that it would not make sense to provide to the outside vendor but rather, it is more reasonable to incorporate it at the last minute. In a particular embodiment, the content items can be templates with specific fields that are filled in by the RSS catcher 220 or the web server 224. In another embodiment, the secure content can be requested from secure information systems running within a company's data center. Those skilled in the art will appreciate that there are a wide variety of reasons that only a partial content item needs to be generated by an outside vendor and then completed prior to sending out and the present invention anticipates and provides a solution for such uses.

In another embodiment, the rather than the RSS Catcher 220 operating to complete the content item, the web server 224 may perform this function. In another embodiment of the present invention, the confidential, sensitive or other content that a company does not want to provide to an outsourced content provider may be securely encrypted and provided to the content provider. The content provider can then insert the encrypted content into the content item and then send out the completed content items. In this embodiment, the RSS catcher 220 and/or the web server 224 operate to receive the content items, decrypt the encrypted content, and then provide the content items through a single, access controlled RSS feed 234 to a RSS feed recipient 230 operating an RSS reader 232. Alternatively, the RSS feed 234 may be a normal RSS feed and the content can be delivered in its encrypted form. In this embodiment, the RSS reader 232 or the recipient 230 includes the ability to decrypt the encrypted items.

FIG. 2C is a block diagram illustrating another solution for providing multiple content classifications. In this embodiment, the services of a content provider 210 are employed to generate partially completed content items which are delivered to an RSS catcher 220 over communications channel 212 through data network 240. The content items are incomplete in that confidential information needs to be incorporated into the content items. In this embodiment of the invention, the content items are provide to the recipients 230 over a non-access controlled RSS feed 234 and the confidential information is provided over an access controlled RSS feed 236. In this embodiment, an RSS reader/merger 252 operates to receive the two RSS feeds and merge them into a single feed for the recipient 230.

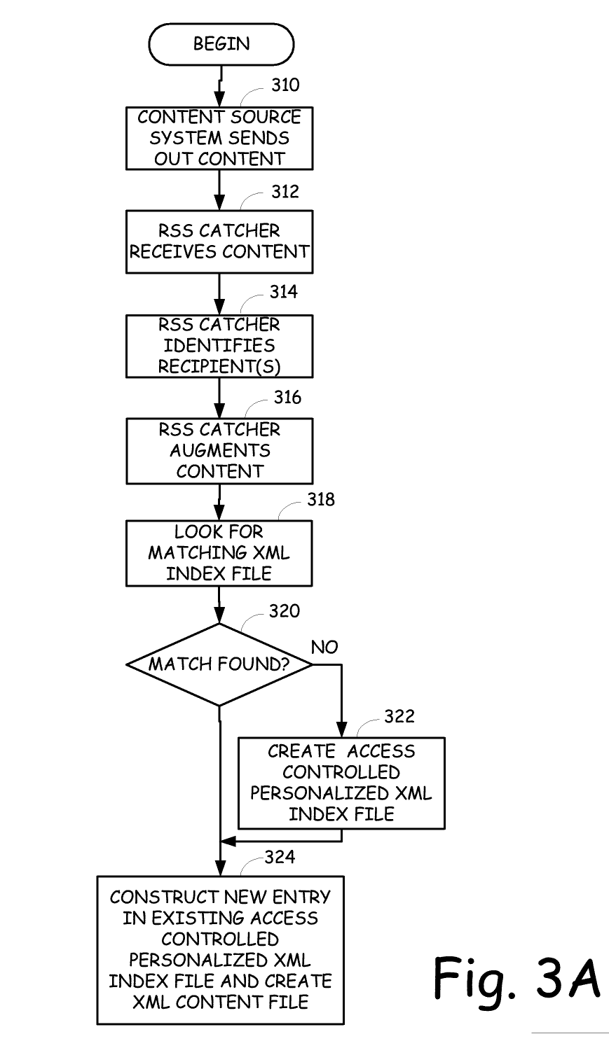

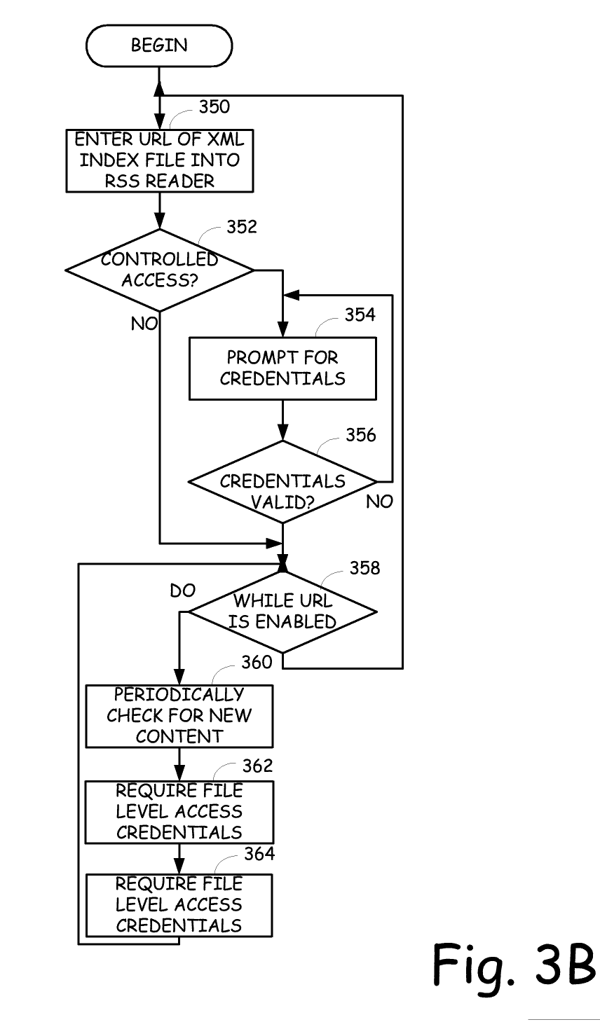

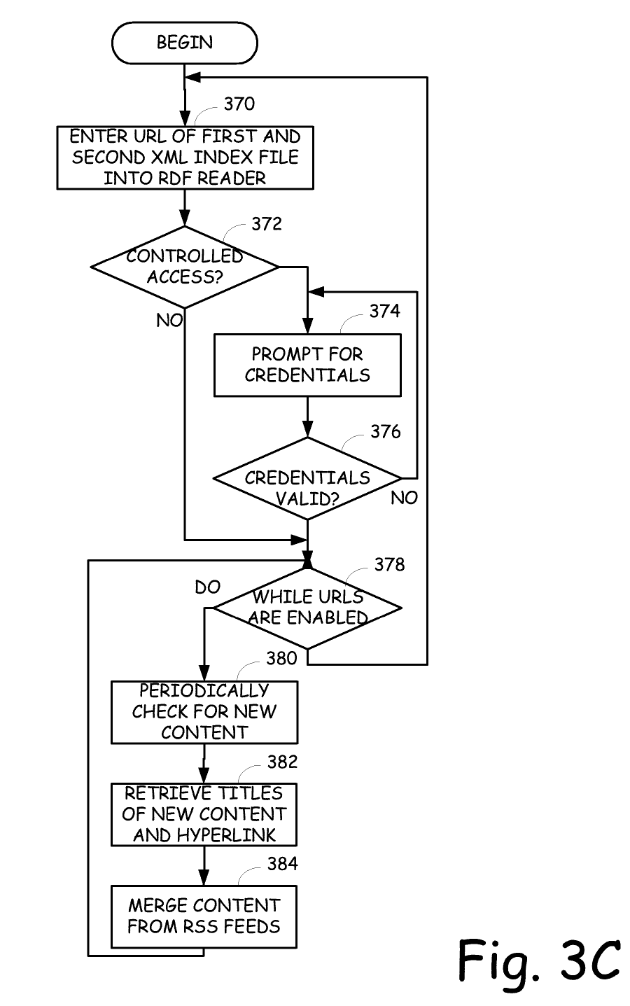

FIG. 3A is a flow diagram illustrating the steps involved in the delivery of mixed content classifications content items using a secured personalized RSS feed for content delivery. Advantageously, this aspect of the present invention allows a user to selectively control the reception of electronic data from a source, and to obtain confidential reports or content items that are at least partially generated employing the services of an outsourced content provider. Processing begins at step 310 with a content delivery system 210 sending out partially completed content items. Such content items may include templates with specific fields left undefined, or simply uncompleted reports. In addition, rather than providing incomplete templates, the content item may be virtually complete and include one or more placeholders or tags in which the content catcher is to augment by providing additional content in their place. Varying embodiments of the present invention can utilize varying means for sending the content such as FTP, SMTP, proprietary feeds, etc. and those skilled in the art will appreciate that other methods for transferring the data out are also anticipated. The content is transferred over a data network 240 to the RSS Catcher 220. The RSS Catcher 220 is setup to receive the output from the content delivery system 210 for the purposes of capturing the content 312. In one embodiment, the RSS Catcher 220 examines the content items to identify the intended recipient(s) at step 314. In other embodiments, the RSS Catcher 220 may simply receive the content items and either receive information regarding the intended recipients at an earlier or later time, or generate this information internally. For the described embodiment, if the content items are email messages, this step may involve examining the data that prefixes the @ symbol in the email address.

At step 316, the content items are augmented by the RSS Catcher 220 by filling in the incomplete fields or portions of the content item with the appropriate data. Such data can be obtained in a variety of fashions but those skilled in the art will appreciate that they will come from other business or information systems be operated in the company's secure data center along with the RSS catcher. The provided data may be sensitive, confidential, adult oriented, private, public, etc. or the content may simply be unclassified and sensitive. Based on the content classification and the identity of the intended recipients, the RSS message may be flagged to require the recipient to authenticate themselves before the message is displayed. If a match is found 320, processing continues at step 322, otherwise processing continues at step 324.

At step 322, a content item for the identified recipient at the identified classification is being provided for the first time. In response to the reception of the content item, an RDF or an XML file is created for the recipient and processing continues at step 324.

For the purposes of this example, it will be appreciated that an RSS feed consists of two file types. One file type, an index or main file, houses the bulk of the RSS feed information—the headers, indexes, abstracts, links, etc. The entries within the index or main file, referred to in this example as the XML index file, may typically include a link to another HTML or XML based file that includes a full copy of the article, publication or data that is being referenced in the XML index file.

At step 322, the intended recipient of the content item does not have an associated XML index file for the identified classification level. Thus, a new XML index file for that classification is created and stored on the web server 230. In an exemplary embodiment, the name of the XML index file incorporates the identify of the intended recipient, or a secret code generated there from, that was extracted from the content item. The name of the XML index file may also incorporate an id tag related to the classification level of the content within that XML index file. The name of the XML index file is then included in the URL that is used to access the XML index file.

At step 324, the received content item is then processed and incorporated into the appropriate XML index file. This process can be performed in a variety of ways. As a non-limiting example for an email message content item, the HTML components of the email message are placed into the XML index file and the subject of the email message is used as the title of the XML index entry. Thus, the title field of the XML index entry is set to the subject of the email message. The email addressing and routing information is stripped out and discarded. The summary of the XML index file entry can be the title or a paraphrase or abstract of the body of the email. In addition, the email messages may include a particular key word or format that allows a summary to be identified and extracted. For instance, the metadata of the email message may house the summary or the summary may be included and extracted from the textual body of the email message through an intelligent parsing algorithm. In addition, key words to identify the summary or abstract can be identified. For instance, the paragraph following the header “summary” may be placed into the summary field of the XML index entry.

In summary, the RSS catcher operates to receive content items either from one or multiple sources, or to generate/receive content items internally. The content items are received from outsourced content providers are incomplete. The RSS Catcher 220 operates to complete the content items by merging confidential or sensitive information into the content item. The classification of the additional information is used to determine the type of XML index file created for the intended recipient of the content. Thus, a non-confidential report can be generated by an outsourced content provider, and augmented by the RSS Catcher to include confidential information and then be provided to a recipient over a controlled access personalized RSS feed.

RSS technology enables a user to selectively enable the reception of particular information. If a user elects to receive certain electronic content from a particular provider using an RSS feed, the user simply enters a URL corresponding to the desired RSS feed into his or her RSS reader, selects the interval for checking for new information, and then simply sits back and waits. In addition, with newer solutions like that available from YAHOO, the URL remains hidden and it is added to the RSS feed by simply clicking on a browser or icon. As new information becomes available in the XML index file associated with the RSS feed, the RSS reader detects the same and notifies the user. The user can then examine the title of the new content, review the summary or decide to download the entire message.

FIG. 3B is a flow diagram illustrating the steps involved in an exemplary embodiment of the RSS reader operation utilized within the present invention. Within the context of the present invention, the user is able to selectively receive messages or content directed towards the user by enabling the RSS feed for that content. In operation, a user enters a URL into his or her RSS reader (step 350). The URL, as described above, is user specific and content classification specific. Thus, for user A to obtain classification level 1 content, the user must enter the URL corresponding with that content. Thus, a user may have multiple classifications of content that all require different credentials to access the information. At step 352, when the entered URL is accessed, the access rights to the associated XML index file are examined. If the access to the file is controlled (i.e., requires a password or some other control mechanism), then at step 354 the user is prompted to provide the necessary credentials. If the access to the file is not controlled, then processing continues at step 358.

It should be understood that although the most typical embodiment simply provide for public content that is accessed without any control, and confidential content that is accessed from a password controlled XML content file or a single message file, other classifications and access requirements are also anticipated. For instance, the content in the file may be encrypted for one classification of content. In other embodiments, passwords of varying lengths may be used for various levels of classification. For instance, highly confidential content may require a 20 character password and lower confidential content may simply require a 4 character password. In either case, the credentials are validated at step 356. If the credentials are valid, processing continues at step 358. Otherwise, processing returns to step 354 to request the credentials again and or provide hacker alerts to a system administrator if the credentials entered are repeatedly invalid.

At step 358, while the reader is configured to receive the RSS feed associated with the entered URL, the process simply passes through a continuous loop (decision block 358). At step 360, the continuous loop includes the step of examining the XML index file to determine if there is additional data, such as new articles available or previous articles or entries being modified, or data that has not previously been received or reviewed by the user, existing within the XML index file associated with the user. If new data exists, the process retrieves a webpage, and possibly the summary of the stored message 362. In addition, the user may receive a hyper-link, which can be imbedded within the summary, and when actuated will allow the user to download the entire web page. At step 364, if the underlying XML content file is access controlled, the user is required to provide access credentials to access the file. Advantageously, this aspect of the present invention allows users to control the reception of the data from various providers because the data is not obtained until the user actually enables the RSS feed of the data. Additionally, the content items may be augmented by the providing company by inserting confidential or sensitive information, thereby causing the RSS feed to be access controlled.

FIG. 3C is a flow diagram illustrating the steps involved in an exemplary embodiment of the present invention that provides dual RSS feeds to a merging RSS reader. In operation, a user enters at least two URLs into his or her RSS reader (step 370). One URL is associated with a non-access controlled RSS feed and the other with an access controlled RSS feed. At step 372, when the entered URLs are accessed, the access rights to the associated RDF files are examined. If the access to one or more of the files is controlled (i.e., requires a password or some other control mechanism), then at step 374 the user is prompted to provide the necessary credentials. If the access to the file is not controlled, then processing continues at step 378

It should be understood that although the most typical embodiment simply provide for public content that is accessed without any control, and confidential content that is accessed from a password controlled XML index file, other classifications and access requirements are also anticipated. For instance, the content in the file may be encrypted for one classification of content. In other embodiments, passwords of varying lengths may be used for various levels of classification. For instance, highly confidential content may require a 20 character password and lower confidential content may simply require a 4 character password. In either case, the credentials are validated at step 376. If the credentials are valid, processing continues at step 378. Otherwise, processing returns to step 374 to request the credentials again and or provide hacker alerts to a system administrator if the credentials entered are repeatedly invalid.

At step 378, while the reader is configured to receive the RSS feeds associated with the entered URLs, the process simply passes through a continuous loop (decision block 358). At step 380, the continuous loop includes the step of examining the XML index files to determine if there is additional data, such as new articles available or previous articles or entries being modified, or data that has not previously been received or reviewed by the user, existing within the XML index file associated with the user. If new data exists, the process retrieves a webpage, and possibly the summary of the stored message 382. In addition, the user may receive a hyper-link, which can be imbedded within the summary, that allows the user to download the entire web page. The RSS reader then merges the content received over the RSS feeds into a single content item package for the user 384. Thus, the user is able to receive confidential information through an RSS feed or simply non-confidential information by only accessing the non-access controlled RSS feed.

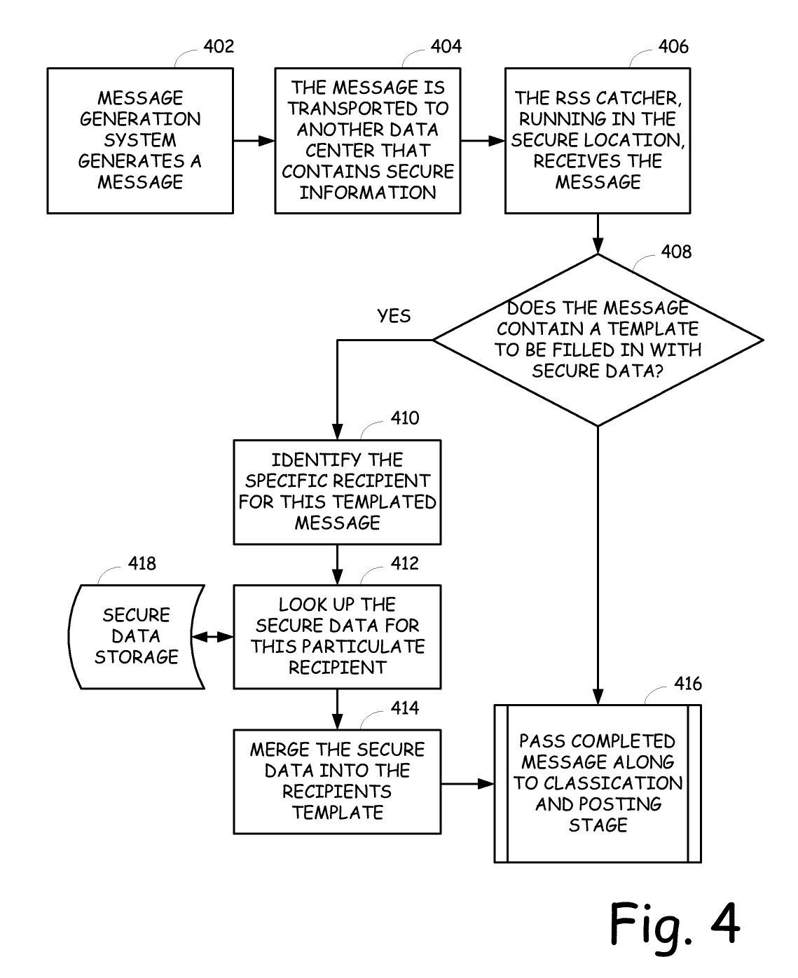

FIG. 4 is a functional block diagram illustrating the states involved in an exemplary embodiment of the present invention. Initially, a message generation system generates a message 402. The message generation system is typically an outsourced service that resides outside of a company's secured intranet; however, in other embodiments it could be an internal function as well. The message is then transported to another data center that contains secure information 404. Again, the next data center can be an outsourced entity residing outside of the company's secured intranet but more typically, such a service is located within the intranet or provided through a secure communication channel. The RSS catcher, running in the secure location, receives the message 406. At step 408, it is determined whether the message contains a template to be filled in with secure data. If so, the specific recipient for this templated message is identified 410 and the secure data for this particulate recipient is obtained 412 by examining a secure data storage 418. The secure data is then merged into the recipient's template 414 and the completed message is passed along to classification and posting stage 416.

Another aspect of the present invention is to provide a personalized RSS feed for a user based on generating a secure/secret URL for accessing the RSS feed. The portion of the secure/secret URL is referred to as a private identity code. The private identity code links a particular user with a particular content provider meaning that if a user accesses an RSS feed based on a particular private identify code, the content should be coming from a particular content provider. In operation, a user can provide a private identity code to a particular content provider to be used as the basis of an RSS feed for the user. The content provider, and the content provider alone, can utilize this private identity code in establishing an RSS feed for the subscriber. This is accomplished by the content provider creating an XML index file whose file name or URL includes the private identity code. To access the RSS feed, the user enters the URL into an RSS reader.

For providing multiple RSS feeds for differing classes, the same private identity code can be used for each file with the URL containing an additional element to identify the classification of the feed or, a unique private identity code can be generated for each user at each classification level.

One aspect of the private identity code is that the user has a significant level of assurance that someone else is not going to be able to guess his or her unique identity code and thus, subscribe to the user's personalized RSS feed—which could contain confidential information. In another embodiment of this aspect of the present invention, rather than a user providing the private identity code, a unique character string can be generated and used to uniquely identify or define an RSS feed for a particular user and from a particular content provider or class of content providers. In this embodiment, when a new user subscribes to a particular personalized RSS feed, a character string or a random code is generated for the user and is associated with the user's login name or user ID. The random code can be any of a variety of sizes and can be generated using any of a variety of techniques. A significant element of this aspect of the invention is that the character string should be unique from other character strings generated for other users and, it should not be easily determinable.

As the size of the unique character string increases, and the sophistication of the generator matures, the character string can become more and more secure, in that it becomes exceedingly more difficult to guess or reverse engineer what user ID should be associated with the character string. In one embodiment of the present invention a character string of length 50 characters is utilized. Once the unique character string is created, the content provider sends data through an RSS feed in which the XML index file name is based on utilizing that particular character string. The user can control who is able to provide him or her information by deciding what personalized RSS feeds to enable. As a result, the user is not required to give out his or her email address nearly as often and as such, the user is then able to retain the usefulness of his or her standard email account and greatly limit the parties that are aware of the user's email address. The user can selectively determine what content to examine and the timing of when that content is brought to the user's attention through the use of the personalized RSS feeds.

Another variation of this aspect of the present invention is directed toward the creation of a unique or personalized feed for a user that already has a relationship with a content provider business. In such an embodiment, the user may already have a username and/or login name. The unique character string for such users needs to be able to be stored, retrievable, or at least regenerated in case the user forgets the value of the string. In one embodiment, a random unique ID is generated and stored into a database along with other user information already kept and maintained for each user. This information can include the name, address, telephone number, etc. of the user. A disadvantage of this embodiment is that existing databases will require some level of modification to operate with RSS feeds. In another embodiment, the unique string is generated as a hash function seeded by a unique and easily remembered input. In general, a hash algorithm takes an input value and produces a unique string. The goal of a good hashing function is to be collision free or at a minimum, have a very high probability that a collision will not occur. A collision is when a hash algorithm actually generates the same output value for more than one set of input values. By ensuring that the hash output has more characters than the hash input, this probability is greatly improved and can be guaranteed.

Because a hash algorithm is a one way mathematical manipulation, the actual user data cannot be recreated by reversing the hash algorithm. In addition, for a given input value, the hashing algorithm will always generate the same output value. Thus, if a user needs to create a unique ID, the user can provide input that is secure, but easily recalled by the user, to the hashing algorithm. If the input data consists of information that is already stored within the database entries for the use, the present database structure in current on-line systems would not have to be changed in order to implement such a system. The data that is already stored on behalf of a user or that is clearly recalled by the user and easily provided is also used to create the unique character string on the fly, as needed by the RSS catcher. Thus, this aspect of the present invention allows for the provision of the personalized RSS feeds without having to require IT departments to add RSS ID fields to their customer databases. Rather, the identity code for the RSS ID can be re-created on demand by re-hashing the ID or personal information a customer already has, such as the customer's user name and a password or PIN. Thus, there is no requirement for a database schema change, the IT department's involvement can be minimized and no storage requirements for RSS ID are required.

Thus, the present invention provides an RSS catcher that can be used to capture output generated by a content source, generated internally, or provided through a memory medium and convert this information into multiple RSS feeds at differing classification levels that can be subscribed to, enabled, and accessed as desired by users or intended recipients of the content. Advantageously, a user can receive content through a personalized RSS feed that is confidential and access through a password protected XML index file or, that is not confidential.

While the foregoing specification illustrates and describes the various embodiments of this invention, it is to be understood that the invention is not limited to the precise construction herein disclosed. The invention can be embodied in other specific forms without departing from the spirit or essential attributes. In addition, various aspects of the present invention have been described. Not all of the aspects are required to gain novelty and various embodiments may utilize on a subset of the various aspects. Accordingly, reference should be made to the following claims, rather than to the foregoing specification, as indicating the scope of the invention.

What is claimed is:

1. A system that provides the controlled delivery of multi-class content to a user, the system comprising:
a content source that is operable to send content items directed towards a user through the use of an address identifier for each content item;
a content catcher that is operable to:
receive a content item;
identify the address identifier;
modify the content item;
based at least in part on at least a portion of the address identifier for the pushed content item, generating a substantially unique identifier;
creating an RSS based file having a URL that is based at least in part on the substantially unique identifier and that contains the modified content item.

2. The system of claim 1, wherein the received content item comprises a partially completed template and the content catcher is operable to modify the content item by inserting additional content into the partially completed template.

3. The system of claim 1, wherein the received content item comprises a partially completed template and the content catcher is operable to modify the content item by inserting confidential content into the partially completed template.

4. The system of claim 1, wherein the received content item includes one or more content place holders and the content catcher is operable to modify the content item by inserting content into the one or more content place holders.

5. The system of claim 1, wherein the received content item includes one or more content place holders and the content catcher is operable to modify the content item by inserting confidential content into the one or more content place holders.

6. A method for providing the controlled delivery of multi-class content to a user, the method comprising the steps of:
receiving a content item directed towards an intended recipient;
modifying the content item to include data at a particular classification level; and
determining if this is the first content item to be provided to the intended recipient, and if this is the first content item:
creating a URL that includes a unique identifier;
creating an XML index file that is accessible via the URL; and
placing at least a portion of the content of the modified content item within the XML index file;
creating an XML content file;
placing a link to the XML content file in the XML index file;
placing a substantial portion of the content of the modified content item within the XML content file;
providing access control to the XML content file, whereby utilizing an RSS reader, the intended recipient can access the content.

7. The method of claim 6, wherein if in the examining step it is determined that this is not the first content item to be provide to the intended recipient, further comprising the steps of:
determining the XML index file that is associated with the intended recipient;
modifying the XML index file by placing the at least a portion of the content of the modified content item within the XML index file.

8. The method of claim 7, wherein the content item is an email message that includes an address identifier and a partially completed template report, and the step of placing the content of the item within the XML index file comprises:
creating an entry in the XML index file and setting the title of the entry to the subject of the email message; and
creating a link to and XML content file containing the body of the email message and placing the link in the summary of the entry.

9. The method of claim 8, wherein the step of modifying the content item further comprises completing the partially completed template report.

10. The method of claim 8, wherein the step of modifying the content item further comprises merging confidential information into the partially completed template report.

11. The method of claim 6, wherein the step of modifying the content item further comprises merging confidential information into the content item.

12. A method for providing RSS feeds wherein a portion of the content is created by one entity and a confidential portion is added to the content by another entity, the method comprising the steps of:
receiving partially completed content items from a first entity directed towards one or more users;
modifying one or more of the content items;
for a first content item for a particular user:
creating a URL that includes a substantially unique identifier;
creating an XML index file that is accessible via the URL;
placing summary information pertaining to the first content item within an entry in the XML index file;
creating an XML content file;
placing a link to the XML content file within the entry in the XML index file; and
placing a substantial portion of the content item within the XML content file.

13. The method of claim 12, further comprising the steps of, for a next content item for the particular user:
placing summary information pertaining to the next content item within a next entry in the XML index file;
creating a next XML content file;
placing a link to the next XML content file within the next entry in the XML index file; and
placing a substantial portion of the next content item within the next XML content file.

14. The method of claim 13, wherein the step of creating an XML index file further comprises the step of creating a password controlled XML index file if the content obtained through the XML index file is at a particular classification level.

15. The method of claim 13, wherein the step of creating an XML index file further comprises the step of creating a non-password controlled XML index file if content obtained through the XML index file is at a particular classification level.

16. The method of claim 13, wherein the step of creating an XML index file further comprises the step of creating a password controlled and encrypted XML index.

17. The method of claim 13, wherein the step of modifying the content item further comprises completing the partially completed template report.

18. The method of claim 13, wherein the step of modifying the content item further comprises merging confidential information into the partially completed template report.

19. A method for providing confidential information RSS feeds for an intended recipient, the method comprising the steps of:
receiving content items directed towards one or more users;
for each content item, identifying confidential data, if any, that is associated with the content item;
merging the content time with the identified confidential data to create a modified content item;
for a first modified content item for a particular user:
creating a URL that includes a substantially unique identifier;
creating a first XML index file that is accessible via the first URL;
creating a first XML content file and placing a substantial portion of the first modified content item within the first XML content file
creating an entry in the XML index file that contains information pertaining to the first content item and a link to the first XML file containing the content of the first content item.

20. The method of claim 19, further comprising the step of, for a next content item for the particular user, creating an entry for the next content item within the XML index.
